(19) United States
(12) Patent Application Publication
(10) Pub. No.: US 2010/0116413 A1
(43) Pub. Date: May 13, 2010

(54) Methods of manufacturing ceramic board and electronic device

(75) Inventors: Kazumasa Tanaka, Tokyo (JP); Tatsuya Kojima, Tokyo (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 12/591,118

(22) Filed: Nov. 9, 2009

(30) Foreign Application Priority Data
Nov. 12, 2008 (JP) 2008-290357

(51) Int. Cl. C03B 29/00

(52) U.S. Cl. 156/89.12; 156/89.11

(57) ABSTRACT

The present invention relates to a method of manufacturing a ceramic board comprises the steps of forming a green ceramic board 11 by laminating at least a plurality of green sheets, forming a unit 8 comprising the green ceramic board 11 and a fired porous ceramic body 5, in which both main surfaces 11a and 11b of the green ceramic board are directly sandwiched between fired porous ceramic bodies 5a and 5b, and firing said unit 8. Many through-holes penetrating the front and back surfaces are formed in said fired porous ceramic bodies 5a and 5b. According to the present invention, it is possible to provide a method of manufacturing a ceramic board, being flat and having no firing, stain, easily and efficiently.

### BACKGROUND OF THE INVENTION

1. Field of the Invention

The present invention relates to methods of manufacturing a ceramic board and an electronic device, specifically relates to a method of manufacturing a ceramic board, being flat and reducing the generation of firing stain, and a method of manufacturing an electronic device using the ceramic board manufactured by this method.

2. Description of the Related Art

A ceramic electronic device is widely used as a small-sized, high-performance, highly-reliable electronic device, and the number of pieces used in an electrical equipment and electronics is increased. With recent demand for down-sizing and higher performance of equipment, a demand for further down-sizing, higher performance and higher reliability is increased in a ceramic electronic device.

However, a ceramic electronic device having circuit function (conductor pattern) is small in dimension, and difficult to manufacture in a form of an individual device in terms of production efficiency and facilities, etc. Therefore, there is known a method of manufacturing a ceramic electronic device, comprising the steps of cutting a ceramic board wherein green sheets are laminated and forming a circuit on a plurality of chips, or cutting a ceramic board wherein a circuit pattern is formed to obtain a plurality of chips.

The above ceramic board can be obtained by firing a board in a green state (green ceramic board), for example, loading on a ceramic setter plate and firing the same. However, when shrinkage at firing is uneven, a flat ceramic board cannot be obtained, and for instance, there may be found deformation (warpage) such that edges of the board is heaved in a direction opposite to the setter plate side.

When dividing the ceramic board with warpage to obtain individual cuboid chip parts, the parts located in the edges of the board become rhombic, which can no longer be products and also cause the other problem such as inaccurate solder-mounting in a component mounting step.

To prevent warpage, both sides of a green ceramic board can be sandwiched between ceramic setter plates for capturing the board so that there is no space between the board and the setter plates and then fired. In this case, organic components (carbon residue) such as binder remained in the green ceramic board may not be removed smoothly, and cause a sudden and rapid exothermal reaction. With this exothermal reaction, colored stain called firing stain can be caused on the board after firing. With such firing stain, in the ceramic electronic device in which a circuit is formed, conductive material constituting the circuit can swell and break, resulting in reduction in electric and mechanical properties.

Therefore, it has been required that these problems of warpage and firing stain can simultaneously be overcome.

The Japanese Unexamined Patent Publication H6-329476 discloses a method for firing a low-temperature fired ceramic board which is sintered at a low temperature of 1000° C. or less, comprising the steps of sandwiching both surfaces of the board in a green state between green sheets having higher sintering temperature than that of the board, arranging a porous ceramic setter plate further thereon and arranging a ordinary setter plate therebelow.

In the Japanese Unexamined Patent Publication 2003-2750, both surfaces of the board in a green state are sandwiched between green sheets for capturing having a sintering temperature higher than that of the board, and a porous ceramic setter plate is arranged further outside. In addition, a binder pyrolyzed at lower temperature than decomposition temperature of a binder included in the board is used as a binder of the green sheet.

However, in the method disclosed in the Japanese Unexamined Patent Publication H6-329976, the ordinary setter plate is arranged on the lower surface of the board, so that it can be predicted to cause firing stain due to exothermal reaction of carbon residue at firing. Also, when using a board having high sintering temperature, it is necessary to produce a green sheet with material having higher sintering temperature than that of the board, so that it is sometimes difficult to select the material. Also, since unsintered green sheet is used, it is inferior in handling in view of strength when carrying the board sandwiched between green sheets and loading the same into a furnace.

Also, in the method disclosed in the Japanese Unexamined Patent Publication 2003-2750, it is necessary to select the binder for the green sheet depending on the type of the binder included in the board, so that it is sometimes difficult to select the type of the binder. Further, as in the Japanese Unexamined Patent Publication H6-329476, the use of unsintered green sheet may cause to be difficult to handle.

### SUMMARY OF THE INVENTION

The present invention has been made in view of such a situation, and has a purpose to provide a simple and efficient method for manufacturing a flat ceramic board without firing stain.

### MEANS FOR SOLVING THE PROBLEM

To attain the above purpose, a method of manufacturing a ceramic board according to the present invention comprises forming a green ceramic board by laminating at least a plurality of green sheets, forming a unit comprising the green ceramic board and a fired porous ceramic body, in which both main surfaces of the green ceramic board are directly sandwiched by the fired porous ceramic bodies, and firing said unit, wherein a plurality of through-holes, which penetrate through front and back surfaces, are formed in said fired porous ceramic body.

In the method of manufacturing a ceramic board according to the present invention, both main surfaces of a green ceramic board before firing are sandwiched directly between fired porous ceramic bodies, in which many through-holes are formed, to form a unit comprising a green ceramic board and fired porous ceramic bodies.

In this unit, both main surfaces of the green ceramic board before firing are sandwiched between fired porous ceramic bodies having through-holes, so that carbon residue in the green ceramic board can be released out of the board smoothly via the through-holes even at firing. As a result, rapid exothermal reaction does not occur, resulting in no firing stain found in the ceramic board after firing.

Then, by directly sandwiching both surfaces of the green ceramic board before firing between the fired porous ceramic bodies, it is possible to effectively prevent warpage of the fired ceramic board.

Also, since the fired porous ceramic body has already been fired at higher temperature (e.g. at 1400° C. or more) than sintering temperature of the green ceramic board, it is applicable, for example, for manufacturing the ceramic board sintered at more than 1000° C.

Also, by sandwiching relatively low-strength green ceramic board between relatively high-strength fired porous ceramic bodies, this unit is superior in handling, and allows improving the efficiency in manufacturing process.

Preferably, said unit is supported by a supporting member so as to allow both main surfaces of said green ceramic board being communicated with an open space through said through-hole formed on said fired porous ceramic body. More preferably, said unit is supported by said supporting member so as to have a length of said open space of 0.5 mm or more in a direction to sandwich said green ceramic board.

Since both surfaces of the green ceramic board contact with the open space through the through-hole of the fired porous ceramic body, organic components remained in the board can be more smoothly released to the open space. Also, open space exists in a direction to sandwich the green ceramic board, i.e. in the side of both main surfaces of the green ceramic board, firing heat can be evenly provided to the green ceramic board via the through-hole at firing. As a result, shrinkage behavior of the green ceramic board can be even, so that warpage of the ceramic board after firing can further be prevented, resulting in a flat ceramic board.

Especially, there is void space (open space) with 0.5 mm or more in the direction to sandwich the green ceramic board, the above effect can be increased. Note that the open space may have a size such that at least carbon residue can sufficiently be released, and may be, for example, space in a firing furnace.

Preferably, porosity of said fired porous ceramic body is 30 to 85%. By having the porosity in the above range, the above effects are enhanced.

Preferably, the method comprises stacking a plurality of units before firing. Since the unit is easy to handle as mentioned earlier, it can be easy to accumulate the units in a furnace, resulting in improving the efficiency in manufacturing process.

Preferably, a conductor pattern is formed in said green ceramic board. Also preferably, a plurality of green chips to be electronic device elements after firing is formed in said green ceramic board.

Even when forming conductor pattern etc. in the green ceramic board and combining different materials, the above effect can be obtained.

The method of manufacturing an electronic device according to the present invention comprises dividing the ceramic board manufactured by any one of the above methods of manufacturing to obtain an individual device element.

The ceramic board manufactured by the above method is flat, and has no firing stain, so that an electronic device, excellent in electric and mechanical properties, can efficiently be manufactured by dividing this ceramic board.

According to the present invention, it is possible to obtain a ceramic board wherein warpage is prevented and no firing stain appears. In addition, because of the above constitution, it is possible to obtain the above ceramic board easily and efficiently regardless of a material of the ceramic board, etc. By using such a ceramic board, an electronic device having good properties can efficiently be manufactured.

### BRIEF DESCRIPTION OF THE DRAWINGS

Hereinafter, the present invention will be described based on embodiments shown in drawings.

FIG. 1A is a schematic cross-sectional view according to one embodiment of the present invention, showing a ceramic board wherein two-terminal electronic device element is formed; FIG. 1B is a schematic cross-sectional view showing an individual electronic device element obtained by cutting a ceramic board wherein two-terminal electronic device elements are formed; and FIG. 1C is a schematic cross-sectional view showing an individual two-terminal electronic device element wherein external electrodes are formed.

FIG. 2 is a schematic cross-sectional view showing apart of the step of forming a green ceramic board in a method of manufacturing a ceramic board according to one embodiment of the present invention.

FIG. 3A is a plane view of a ceramic setter plate having honeycomb structure as a fired porous ceramic body in a method of manufacturing a ceramic board according to one embodiment of the present invention and FIG. 3B is a cross-sectional view of a ceramic setter plate having honeycomb structure.

FIG. 4 is a schematic view to explain a method for calculating warpage amount in the present invention.

FIG. 5 is a schematic cross-sectional view showing a unit in a method of manufacturing a ceramic board according to one embodiment of the present invention.

FIG. 6 to FIG. 8 are schematic cross-sectional views showing a method of forming a void space (open space) in a method of manufacturing a ceramic board according to one embodiment of the present invention.

FIG. 9 is a cross-sectional view showing the step of stacking a plurality of units in a method of manufacturing a ceramic board according to other embodiment of the present invention.

### DESCRIPTION OF THE PREFERRED EMBODIMENTS

### Green Ceramic Board

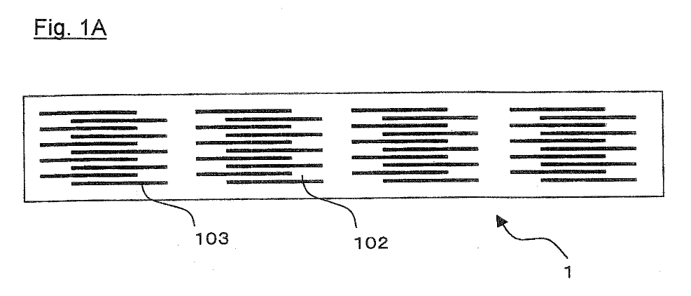

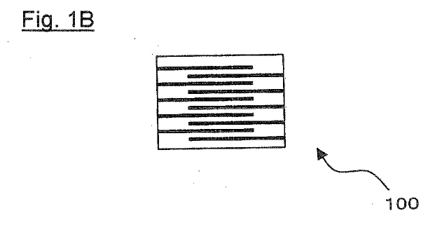

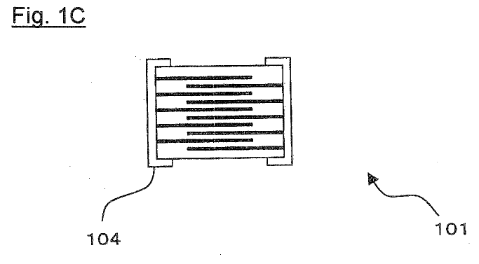

First, a green ceramic board is prepared in the method of manufacturing a ceramic board according to one embodiment of the present invention. The green ceramic board is not particularly limited as far as the green sheets are laminated, and a green ceramic board wherein green sheets and conductor patterns to have circuit function after firing are laminated is prepared in the present embodiment. By firing the green ceramic board, it is possible to obtain a ceramic board 1, for example, as shown in FIG. 1A, which has a constitution wherein ceramic 102 and internal electrode 103 are alternately laminated, and in which a plurality of elements to become two-terminal electronic devices are formed.

The method of forming a green ceramic board by laminating green sheets and conductor patterns is not particularly limited, and there may be mentioned a publicly-known sheet forming method and printing method using a green sheet paste and a conductive paste, etc.

The green sheet paste is prepared by kneading ceramic material, glass material and etc., selected depending on the desired properties, with organic vehicle obtained by dissolving a binder in organic solvent. Note that the green sheet paste may be water-based.

The conductive paste is prepared by kneading conducting material comprising conducting metal such as Au, Ag, Cu, Pt, Pd and Ni and its alloy with the above-mentioned organic vehicle.

The content of the organic vehicle in each of the above-mentioned paste is not particularly limited, and may be ordinary amount, e.g. approximately 1 to 5 wt % for the binder and approximately 10 to 50 wt % for the solvent. Also, additives selected from a variety of dispersant, plasticizer, dielectric, insulator, etc. may be included in each paste if needed.

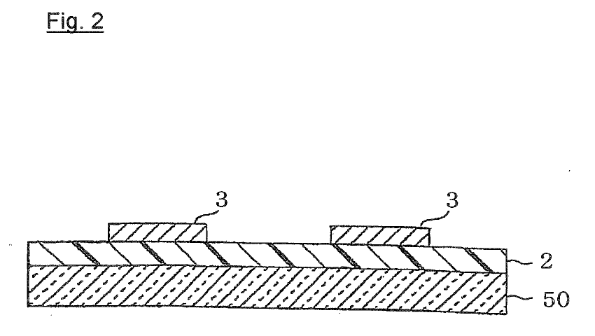

For example, when using the sheet method to form a green ceramic board, a green sheet 2 is formed on a carrier sheet 50 as a support by using the above green sheet paste, and a conductive paste is printed thereon to form a conductor pattern 3 as shown in FIG. 2. Then, the carrier sheet 50 is removed from the green sheet 2 wherein the conductor pattern 3 is formed and the above green sheets 2 are laminated to form a green ceramic board.

The thickness of the green ceramic board is determined depending on the type, use, etc. of the electronic device element formed on the board and not particularly limited. For example, it is approximately 0.1 to 5.0 mm. The shape of the green ceramic board is not particularly limited as far as it is in the form of plates, and is normally a quadrilateral.

Fired Porous Ceramic Setter Plate

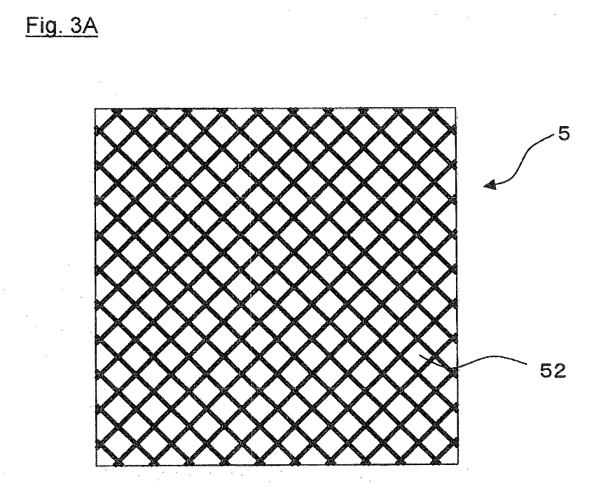

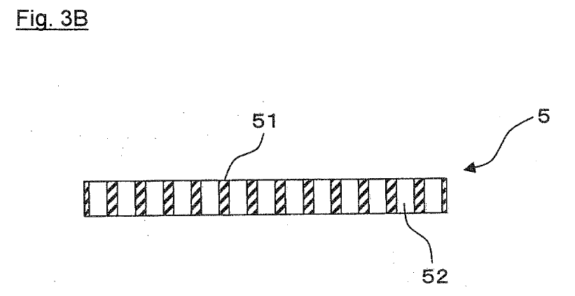

Next, a fired porous ceramicsetter plate is prepared. The fired porous ceramic setter plate is not particularly limited as far as through-holes penetrating the front and back surfaces are formed thereon. In the present embodiment, it is preferable to use a ceramic setter plate 5 having honeycomb structure (hereinafter referred to as a honeycomb setter plate) wherein a large number of through-holes 52 are formed in a certain configuration on its main surface 51 as shown in FIG. 3A and FIG. 3B.

The porosity of the fired porous ceramic setter plate 5 is preferably 35 to 80%, more preferably 50 to 70%. The porosity is a rate of the total area of all through-holes 52 with respect to the area of the face of the fired porous ceramic setter plate 5. When the porosity is too small, carbon residue in the green ceramic board is hardly released outside, and firing stain is liable to appear after firing. In contrast, when the porosity is too large, the strength of the fired porous ceramic setter plate 5 itself can be lowered to cause to be destroyed at firing.

When using the honeycomb setter plate 5 as a fired porous ceramic setter plate, the above porosity can be expressed in the following formula.

Porosity (%)=(Area of through-holes 52×Number of through-holes 52)/Area of main surface 51 of honeycomb setter plate 5

The configuration of the through-hole 52 is not particularly limited, and may include polygonal configuration such as quadrangle, rhombic and triangle, and circle. It is preferable to be square or rectangular.

Also, its diameter of the through-hole is not particularly limited and when the configuration of the through-hole 52 is square or rectangular, the length of a side is preferably 0.1 mm or more. When the diameter of the through-hole is too small, carbon residue in the green ceramic board tend to be hardly released outside.

The applied load of the fired porous ceramic setter plate 5 applied to unit area in the main surface of the green ceramic board is preferably 0.3 to 2.5 g/cm². When the applied load of the fired porous ceramic setter plate 5 is too small, warping stress generated in the green ceramic board at firing cannot be prevented, and warpage is liable to appear in the ceramic board after firing. In contrast, when the applied load is too large, warpage of the ceramic board can be prevented, but the shrinkage of the green ceramic board is liable to be disturbed to cause generation of crack and split in the ceramic board after firing. Note that the applied load of the fired porous ceramic setter plate 5 can be determined by its material, the thickness of the fired setter plate, porosity, etc.

The warpage amount of the fired porous ceramic setter plate 5 is preferably 300 μm or less, more preferably 50 to 200 μm. When the warpage amount is too large, the applied load of the fired porous ceramic setter plate 5 cannot be evenly applied to the green ceramic board to cause warpage in the ceramic board after firing, and since the applied load is locally applied to the green ceramic board, the ceramic board may be broken or distorted.

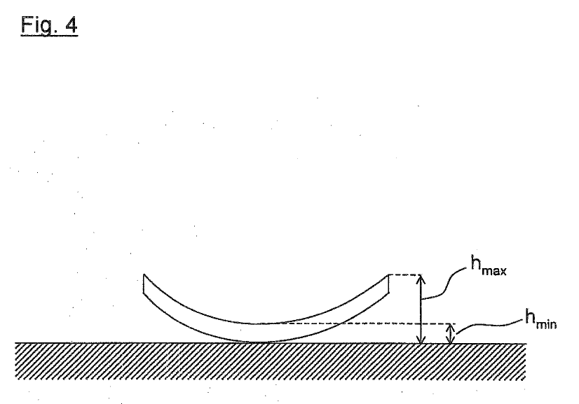

Note that the warpage amount is defined as an amount shown in FIG. 4 in the present invention. Namely, the height “h” from a certain reference surface is measured in the main surface of measuring object (ceramic board or fired porous ceramic setter plate) to obtain the warpage amount by subtracting the minimum height “hₘᵢₙ” from the maximum height “hₘₐₓ”.

The material of the fired porous ceramic setter plate 5 is not particularly limited and it is preferable to use stabilized zirconia, alumina, mullite, etc., which are stable at high temperature, for a green ceramic board having high sintering temperature (for example, 1050° C. or more).

Unit

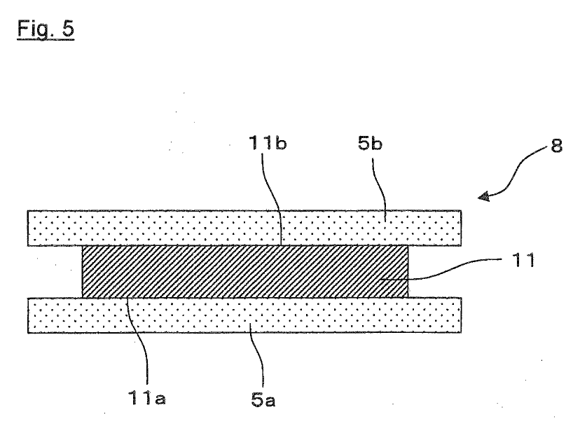

In the present embodiment, as shown in FIG. 5, both main surfaces 11a and 11b of the green ceramic board 11 are sandwiched so as to directly contact with fired porous bodies 5a and 5b, so that a unit 8 is formed. Since the green ceramic board 11 is not yet fired, its strength is relatively low, but the fired porous ceramic bodies 5a and 5b are relatively high in strength. Therefore, it is not necessary to place this unit 8 further on another setter plate, etc., and operations including carrying and loading can efficiently be done by using the unit 8 as a single unit.

After forming the above unit 8, the unit 8 is subject to binder removal step in the present embodiment. The binder removal step indicates a step for volatilizing organic component included as a binder in the green ceramic board 11. The binder removal condition is not particularly limited, and the temperature is 200 to 400° C. and the holding time is 0.5 to 20 hours. For the condition of the binder removal atmosphere, the binder removal can be done in air or reduced atmosphere for example, and reduced atmosphere is preferable when performing the binder removal at a temperature causing oxidization of the internal electrode.

Note that most part of the organic component is volatilized in the binder removal step, but a part of the organic component remains in the green ceramic board after the binder removal. The remaining organic component (carbon residue) can be almost completely volatilized in the firing step.

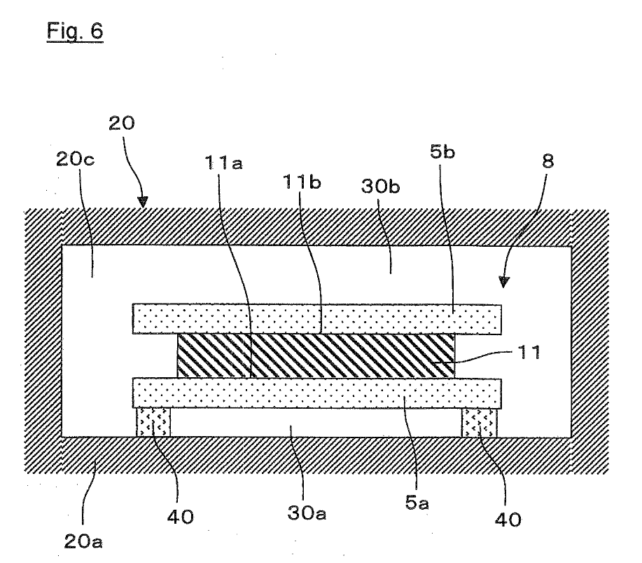

After the binder removal step, the unit 8 is subject to firing. In the present embodiment, the unit 8 is loaded in a firing furnace 20 in the firing step, as shown in FIG. 6, with spacers 40 being placed between a bottom member 20a of the firing furnace and the fired porous ceramic setter plate 5a placed in the main surface 11a of the green ceramic board 11 to provide void space 30a. This void space 30a is not sealed, and communicates with space 20c (open space) in the firing furnace 20 as with void space 30b in the upper side of the main surface 11b of the green ceramic board 11. By providing such void spaces, the organic component remained in the green ceramic board 11 is easy to be volatilized via the through-holes 52 of the fired porous ceramic setter plate 5 (not appeared in the drawing) at firing, and added heat in the firing furnace is evenly conducted throughout the green ceramic board 11 via the through-holes 52 from the void spaces 30a and 30b in both main surfaces 11a and 11b sides. As a result, shrinkage behavior of the green ceramic board 11 is even, so that warpage of the ceramic board after firing can be prevented.

In the present embodiment, the above void space is preferably 0.5 mm or more in height. When the void space is too small, organic components of the green ceramic board 11 tend to be hardly volatilized, and heat conducted to the green ceramic board 11 is also liable to become slightly uneven.

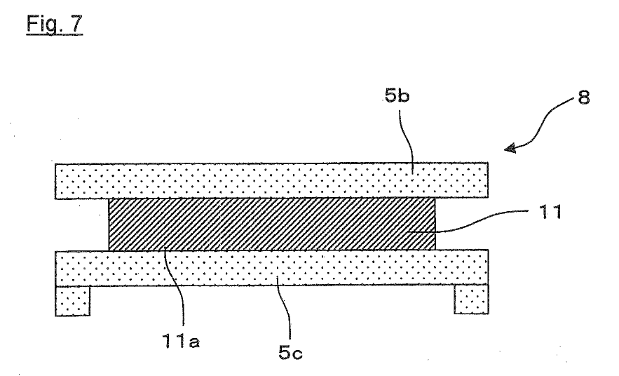

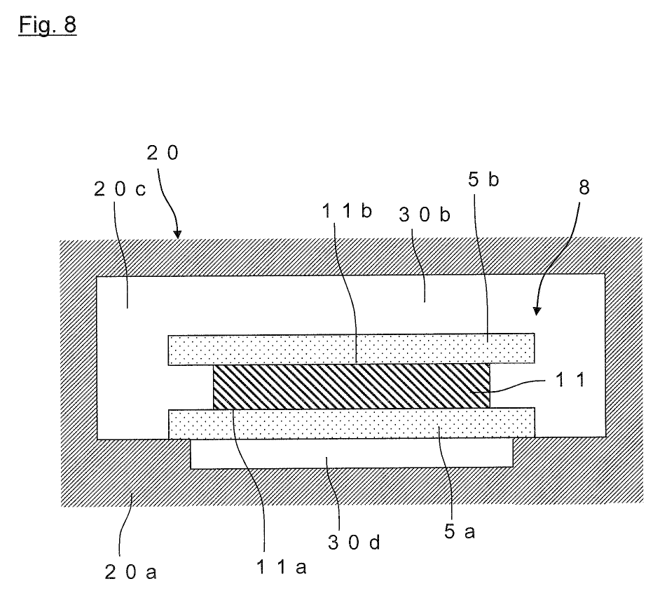

Supporting member for forming the void space is not particularly limited, and for example, as shown in FIG. 7, the fired porous ceramic setter plate 5c itself in the side of the main surface 11a may be provided with scaffold, or as shown in FIG. 8, space (void space) 30d may be formed in the member 20a. Also, the unit may be raised and held to form void space.

Note that the upper limit in height of the void space is not particularly restricted, but in view of efficiency in manufacturing, it is preferable to properly determine the upper limit depending on manufacturing condition of the ceramic board.

The firing condition may be properly determined depending on the ceramic material, material of the conductor pattern, desired properties, etc., and it is preferable to have the following conditions. The firing temperature is 800 to 1400° C., more preferably 1050 to 1350° C. The holding time is 0.5 to 8.0 hours, more preferably 1.0 to 3.0 hours. The firing atmosphere is not particularly limited, and when using base metal, such as Ni, as the conductor pattern, reduced atmosphere is preferable.

In the firing step, by firing the green ceramic board 11 in the form of the above unit 8, warpage of the ceramic board after firing can be reduced, and carbon residue in the green ceramic board 11 can smoothly be volatilized to result in no firing stain in the ceramic board after firing. Also, by providing void spaces 30a to 30d communicating with the space 20c (open space) in the firing furnace 20 in the direction of sandwiching the green ceramic boards 11 (in the lower side of the main surface 11a and the upper side of the main surface 11b of the green ceramic board 11), heat can evenly be applied to both main surfaces 11a and 11b of the green ceramic board 11 via the through-holes 52 of the fired porous ceramic setter plate 5, so that warpage of the ceramic board can further be prevented.

In addition, because the fired porous ceramic setter plate is sintered, there is no need to consider sintering temperature and binder, etc. of the green ceramic board by using the fired porous ceramic setter plate.

The unit after firing is, if required, subject to annealing treatment. The annealing condition may be properly determined.

After that, the fired porous ceramic setter plate is removed from the unit to obtain a ceramic board. When the ceramic board is board 1 shown in FIG. 1A, wherein a plurality of elements to be two-terminal electronic devices is formed, as shown in FIG. 1B, the ceramic board 1 is cut into individual two-terminal electronic device elements 100, which are then subject to the step of forming external electrode thereon.

Since warpage of the ceramic board is prevented, the configuration of the electronic device in the vicinity of the end of the board does not become defective.

Then, as shown in FIG. 1C, external electrodes 104 are formed on an individual chip element cut from the ceramic board, so that an individual electronic device 101 can be obtained.

### Other Embodiments

Note that the present invention is not limited to the above-mentioned embodiment, and can be variously modified within the scope of the present invention.

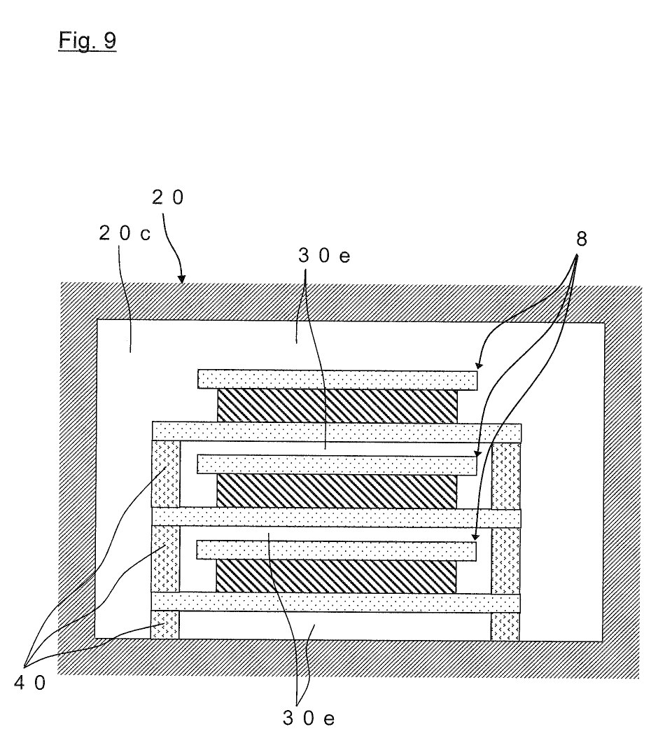

In the above-mentioned embodiment, the step for firing a single unit is described, but for example, as shown in FIG. 9, a plurality of the units 8 may be laminated and fired in the stack. By firing in the stack, large quantity of ceramic boards can be fired in one firing step while showing the effect of the present invention, resulting in increased efficiency in manufacturing. Note that void space 30e can be provided in a direction of sandwiching the green ceramic boards 11, as shown in FIG. 9, by properly adjusting the distance between each unit when stacking.

Also, in the above-mentioned embodiment, the unit is subject to binder removal, but it is unnecessary to do this step on the unit. Namely, the binder removal may be done without sandwiching both main surfaces of the green ceramic board with fired porous ceramic bodies. Since the green ceramic board is not sintered in the step, warpage does not need to be considered. Therefore, as far as firing in the form of the unit at least in the firing step, the effect of the present invention can be successfully obtained.

### EXAMPLE

Hereinafter, the present invention will be explained based on further detailed Examples, but the present invention is not limited to these Examples.

### Example 1

### Green Ceramic Board

First, ceramic material powder, glass material powder and organic vehicle were mixed and kneaded to prepare a green sheet paste. The organic vehicle included binder, organic solvent, and if needed, plasticizer, dispersant, etc.

Next, conductive powder, glass material powder and organic vehicle were mixed and kneaded to prepare a conductive paste. The organic vehicle included binder, organic solvent, and if needed, plasticizer, dispersant, etc.

The above-obtained green sheet paste was coated on polymer film such as PET film by doctor blade method and dried. On the dried green sheet, the above-obtained conductive paste was printed and dried to produce a green sheet in which a conductor pattern having a thickness of 2.0±0.2 μm was formed.

A plurality of the above green sheets were produced and laminated to produce a green ceramic board which green chips to be electronic device elements were formed within.

Unit

As a fired porous ceramic setter plate, a honeycomb setter plate having the porosity shown in Table 1, and warpage of 50 to 200 μm was prepared. Note that the porosity shown in Table 1 indicates a rate of the area of a quadrilateral through-hole of 1.0×1.0 mm with respect to the area of the entire face of the honeycomb setter plate.

Both main surfaces of the above-obtained green ceramic board were sandwiched with two honeycomb setter plates, to form a unit. Note that these two honeycomb setter plates had same porosity.

This unit was subject to binder removal and firing. The binder removal was done under the condition of 300° C.-10 hours, and the firing was done under the condition of 1200° C.-2.0 hours. Note that during the drying step to solidify, the binder removal and the firing, the unit was loaded on a spacer as a support placed in a furnace. The height of the spacer was 0.5 mm. Namely, in each step, void space provided between the bottom surface of the furnace and the honeycomb setter plate in the side of the lower surface of the green ceramic board was 0.5 mm in height.

The honeycomb setter plates were removed from the unit after firing to obtain a ceramic board. The obtained ceramic board and honeycomb setter plates were evaluated as below.

Warpage Amount of Ceramic Board

For the ceramic board after firing, warpage amount was measured by using a noncontact 3D measuring machine. Specifically, the height “h” of the board from the reference surface was measured at 1000 or more spots in the main surface of the board, and warpage amount was defined as a value obtained by subtracting the minimum height “hₘᵢₙ” from the maximum height “hₘₐₓ” as shown in FIG. 4. The warpage amounts were measured for five ceramic boards to determine the average as the warpage amount in Table 1. The warpage amount was preferably 100 μm or less. The results are shown in Table 1.

Firing Stain of Ceramic Board & Thickness of Conducting Body (Thickness of Internal Electrode)

For firing stain of the ceramic board, the external appearance of the board was visually observed to evaluate whether there was colored stain. Also, the board was cut vertically to the laminated face, the cross-sectional surface was subject to mirror polishing, and the thickness of the conducting body (internal electrode) formed within the board was observed by microscope. For the colored stain and the thickness of the internal electrode, five ceramic boards were evaluated. It was preferable not to observe any colored stain for all boards. Also, in the present Example, the thickness of the internal electrode was preferably 2.0 μm or less.

Split/Crack in Honeycomb Setter Plate

The honeycomb setter plate removed from the unit after firing was visually observed whether there was split/crack. No split/crack was preferable. The results are shown in Table 1.

TABLE 1

| | Porosity of | Ceramic board | | |
|---|---|---|---|---|
| | honeycomb | | Firing stain | Honeycomb |
| | setter plate | Warpage | Thickness | setter plate |
| Sample No. | [%] | amount [μm] | of IE* [mm] | split/crack |
| 1 | 10 | 110 | Exist | No |
| | | | 2.8 | |
| 2 | 20 | 93 | Exist | No |
| | | | 2.4 | |
| 3 | 30 | 89 | No | No |
| | | | 2.0 | |
| 4 | 40 | 70 | No | No |
| | | | 1.9 | |
| 5 | 50 | 66 | No | No |
| | | | 1.8 | |
| 6 | 60 | 61 | No | No |
| | | | 1.7 | |
| 7 | 70 | 65 | No | No |
| | | | 1.7 | |
| 8 | 85 | 91 | No | No |
| | | | 1.8 | |
| 9 | 90 | 122 | No | Observed |
| | | | 1.7 | |

*IE = internal electrode

From Table 1, when the porosity was 20 to 85% (Samples 2 to 8), warpage of the ceramic board was confirmed to be 100 μm or less, which was preferable. Also, when the porosity was 10% and 20% (Samples 1 and 2), firing stain was observed, and the thickness of the internal electrode was confirmed to be larger than 2.0 μm. Therefore, Samples 1 and 2 were considered to be deteriorated in electric and mechanical properties. Also, when the porosity was 90% (Sample 9), the strength of the honeycomb setter plate itself was low, so that split and crack were observed in the honeycomb setter plate after firing.

From the above results, it is confirmed that the porosity of the honeycomb setter plate is preferably 30 to 85% to prevent warpage of the ceramic board and to improve electric and mechanical properties of the sample.

### Example 2

Except for changing the height of the void space provided between the bottom surface of the furnace and the honeycomb setter plate at the side of the lower surface of the green ceramic board to the value shown in Table 2, and changing the porosity of the honeycomb setter plate to 70%, a unit was formed, followed by each step of binder removal and firing, as in Example 1. For the warpage amount, the firing stain and the thickness of the internal electrode of the obtained ceramic board, same evaluations were done as in Example 1. The results are shown in Table 2.

TABLE 2

Ceramic board

| | | | Firing stain |
|---|---|---|---|
| | Void space | Warpage | Thickness |
| Sample No. | [mm] | amount [μm] | of IE* [mm] |
| 10 | 0 | 131 | No |
| | | | 2.1 |
| 11 | 0.5 | 95 | No |
| | | | 1.8 |
| 12 | 1 | 85 | No |
| | | | 1.8 |
| 13 | 2 | 80 | No |
| | | | 1.7 |
| 14 | 5 | 74 | No |
| | | | 1.7 |
| 15 | 10 | 68 | No |
| | | | 1.8 |
| 16 | 50 | 65 | No |
| | | | 1.7 |
| 17 | 100 | 65 | No |
| | | | 1.8 |

*IE = internal electrode

From Table 2, when the void space was 0 mm (Sample 10), it was confirmed that warpage of the ceramic board was larger than 100 μm. This might be because heat conduction was not uniform in the honeycomb setter plate in the side of the upper main surface of the board and in the other honeycomb setter plate in the side of the lower main surface of the board since no void space was provided, so that firing shrinkage behavior was different between upside and downside of the board to cause increase in warpage. Also, while no firing stain was observed in all of the samples, in the case of providing no void space (Sample 10), it was observed that the thickness of the internal electrode was slightly increased, and that the internal electrode broke. From these results, properties of the sample can be deteriorated.

### Example 3

Except for changing the porosity of the honeycomb setter plate to 70%, and adjusting the thickness of the setter plate to change the applied load per unit area of the upper surface of the green ceramic board to the value shown in Table 3, a unit was formed, followed by each step of binder removal and firing, as in Example 1. For the warpage amount, the firing stain and the thickness of the internal electrode of the obtained ceramic board, same evaluations were done as in Example 1 and the following evaluation was further performed. The results are shown in Table 3.

Split/Crack in Ceramic Board

The ceramic board after firing was visually observed whether there was split/crack. No split/crack was preferable. The results are shown in Table 3.

TABLE 3

| | | Ceramic board | | |
|---|---|---|---|---|
| | Load per unit | | Firing stain | |
| | area of board | Warpage | Thickness | |
| Sample No. | [g/cm²] | amount [μm] | of IE* [mm] | split/crack |
| 18 | 0.2 | 121 | No | No |
| | | | 1.8 | |
| 19 | 0.3 | 97 | No | No |
| | | | 1.7 | |
| 20 | 0.6 | 72 | No | No |
| | | | 1.8 | |
| 21 | 0.9 | 63 | No | No |
| | | | 1.8 | |
| 22 | 1.3 | 52 | No | No |
| | | | 1.8 | |
| 23 | 1.6 | 55 | No | No |
| | | | 1.7 | |
| 24 | 2.5 | 60 | No | No |
| | | | 1.8 | |
| 25 | 3.0 | — | No | Observed |
| | | | 1.9 | |

*IE = internal electrode

From Table 3, when the applied load was 0.2 g/cm² (Sample 18), it was confirmed that warpage of the ceramic board was larger than 100 μm. Also, when the applied load was 3.0 g/cm² (Sample 25), applied load was too large and therefore, split and crack were observed in the ceramic board after firing, causing it impossible to calculate warpage amount. Note that the results of all samples were good for firing stain and the thickness of the internal electrode.

From the above results, it can be confirmed that load applied per unit area of the main surface of the green ceramic board is preferably 0.3 to 2.5 g/cm².

### Example 4

Except for changing the porosity of the honeycomb setter plate to 70%, and changing the warpage of the honeycomb setter plate to the value shown in Table 4, a unit was formed, followed by each step of binder removal and firing, as in Example 1. For the warpage amount, the firing stain, the thickness of the internal electrode and split/crack of the obtained ceramic board, same evaluations were done as in Example 3. The results are shown in Table 4.

TABLE 4

| | Warpage amount | Ceramic board | | |
|---|---|---|---|---|
| | of honeycomb | | Firing stain | |
| | setter plate | Warpage | Thickness | |
| Sample No. | [mm] | amount [μm] | of IE* [mm] | split/crack |
| 26 | 50 | 63 | No | No |
| | | | 1.7 | |
| 27 | 70 | 62 | No | No |
| | | | 1.7 | |
| 28 | 90 | 68 | No | No |
| | | | 1.7 | |
| 29 | 100 | 64 | No | No |
| | | | 1.8 | |
| 30 | 200 | 75 | No | No |
| | | | 1.8 | |
| 31 | 300 | 89 | No | No |
| | | | 1.7 | |
| 32 | 400 | 110 | No | No |
| | | | 1.8 | |
| 33 | 1000 | 144 | No | No |
| | | | 1.9 | |

*IE = internal electrode

From Table 4, when the warpage of the honeycomb setter plate was 400 μm or more (Samples 32 and 33), it was confirmed that the warpage of the ceramic board becomes larger than 100 μm. This might be because heat is not evenly conducted and the applied load is not evenly applied as well when the warpage of the setter plate becomes larger to cause a part where the setter plate and the green ceramic board do not contact with each other. Note that the results of all samples were good for the firing stain and the thickness of the internal electrode.

From the above results, it can be confirmed that the warpage of the honeycomb setter plate is preferably 300 μm or less.

### Example 5

Using BaTiO₃-based raw material as the ceramic material, a green ceramic board, in which a green chip to be multilayer ceramic capacitor as the electronic device element after firing was formed, was produced. Except for using this green ceramic board, and changing the porosity of the honeycomb setter plate to 70%, a unit was formed, followed by each step of binder removal and firing, as in Example 1 to obtain a ceramic board. The obtained ceramic board was cut to obtain an individual capacitor chip element, and external electrodes were formed on the element to manufacture a multilayer ceramic capacitor.

Also, after the green ceramic board was cut to obtain an individual green chip, binder removal and firing were done to obtain a multilayer ceramic capacitor as a sample of a comparative example.

For the multilayer ceramic capacitor manufactured according to the method of the present invention and the multilayer ceramic capacitor as a comparative example, a capacitance and dielectric loss (tan δ) were measured using a LCR meter, under the condition of alternate current of 1 kHz and voltage of 1 Vrms. For each sample, 20 samples were measured. The results are shown in Table 5.

TABLE 5

| | Capacitor of Compar- | Capacitor produced according |
|---|---|---|
| Properties | ative Example | to the present method |
| Capacity [pF] | 10.2 | 10.3 |
| tan δ [%] | 0.71 | 0.75 |

From Table 5, properties of the multilayer ceramic capacitor manufactured according to the method of the present invention were almost equivalent to properties of the capacitor of the comparative example. However, the method of manufacturing the capacitor of the comparative example was inferior to the method of the present invention, in terms of efficiency in manufacturing, handling, etc.

What is claimed:

1. A method of manufacturing a ceramic board comprising:
forming a green ceramic board by laminating at least a plurality of green sheets,
forming a unit comprising the green ceramic board and a fired porous ceramic body, in which both main surfaces of the green ceramic board are directly sandwiched by the fired porous ceramic body, and
firing said unit,
wherein a plurality of through-holes, which penetrate through front and back surfaces, are formed in said fired porous ceramic body.

2. The method of manufacturing a ceramic board as set forth in claim 1, wherein said unit is supported by a supporting member so as to allow both main surfaces of said green ceramic board being communicated with an open space through said through-hole formed on said fired porous ceramic body.

3. The method of manufacturing a ceramic board as set forth in claim 2, wherein said unit is supported by said supporting member so as to have a length of said open space of 0.5 mm or more in a direction to sandwich said green ceramic board.

4. The method of manufacturing a ceramic board as set forth in claim 1, wherein porosity of said fired porous ceramic body is 30 to 85%.

5. The method of manufacturing a ceramic board as set forth in claim 1 comprising stacking a plurality of units before firing.

6. The method of manufacturing a ceramic board as set forth in claim 1, wherein a conductor pattern is formed in said green ceramic board.

7. The method of manufacturing a ceramic board as set forth in claim 1, wherein a plurality of green chips to be electronic device elements after firing is formed in said green ceramic board.

8. A method of manufacturing an electronic device comprising:
dividing a ceramic board manufactured by the method of manufacturing a ceramic board as set forth in claim 1 to obtain an individual device element.
